(19) United States
(12) Patent Application Publication
(10) Pub. No.: US 2017/0160628 A1
(43) Pub. Date: Jun. 8, 2017

(54) LIGHT SOURCE MODULE AND PROJECTION APPARATUS USING THE SAME

(71) Applicant: Coretronic Corporation, Hsin-Chu (TW)

(72) Inventors: HUNG-YU LIN, Hsin-Chu (TW); CHI-FU LIU, Hsin-Chu (TW); CHUN-LI CHEN, Hsin-Chu (TW); CHI-TANG HSIEH, Hsin-Chu (TW)

(21) Appl. No.: 14/958,646

(22) Filed: Dec. 3, 2015

(51) Int. Cl. G03B 21/20; G03B 21/00; G02B 1/11; G02B 5/02; G02B 5/20

(52) U.S. Cl. CPC G03B 21/208; G02B 5/0294; G02B 5/208; G02B 5/0268; G02B 1/11; G03B 21/2026; G03B 21/005

(57) ABSTRACT

A light source module including a light source and a light diffusion and filtering plate is provided. The light source is configured to provide an illumination light beam. The light diffusion and filtering plate is disposed on a transmission path of the illumination light beam. The light diffusion and filtering plate includes a light-transparent substrate, a light diffusion structure, and a light filtering structure. The light-transparent substrate has a first surface facing to the light source and a second surface opposite to the first surface. The light diffusion structure is disposed on the first surface, and the light filtering structure is disposed on the second surface. The light source module may reduce flicker. Further, a projection apparatus having the light source module is also provided.

### FIELD OF THE INVENTION

The invention relates to a display apparatus, and more particularly to a projection apparatus and a light source module thereof.

### BACKGROUND OF THE INVENTION

A projection apparatus includes a light source, a light valve unit and a projection lens. The light source is used to provide an illumination light beam, the light valve unit is used to convert the illumination light beam into an image light beam, and the projection lens is used to project the image light beam onto a screen to display an image onto the screen.

In a conventional lamp based projection apparatus, a high pressure mercury lamp is usually used as the light source to provide an illumination light beam with high illuminance. When electronic current is applied to the high pressure mercury lamp, a high potential difference is generated between electrodes of the high pressure mercury lamp, and high thermal energy is also generated to convert mercury into mercury steam. The mercury steam is excited by the high potential difference to discharge, and electrons, atoms and ions collide with each other to generate the illumination light beam with high illuminance.

However, in the high pressure mercury lamp, due to a temperature difference caused by the high thermal energy, thermal disturbance is generated between the electrodes, which results in flicker.

A conventional light source module has an infrared/ultraviolet filtering layers on a transparent substrate. The infrared filtering layer is disposed between the ultraviolet filtering layer and the transparent substrate. Radiant heat of the infrared rays accumulates between the infrared filtering layer and a first surface of the transparent substrate. The difference in temperature between the first surface and a second surface opposite to the first surface is large. It causes the transparent substrate to be broken due to uneven heat stress.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

The invention provides a projection apparatus to reduce flicker.

The invention also provides a light source module to reduce flicker, so as to decrease twinkle/flicker of an image projected onto a screen and improve the uniform illuminance of the image.

Other advantages and objects of the invention may be further illustrated by the technical features broadly embodied and described as follows.

In order to achieve one or a portion of or all of the objects or other objects, an embodiment of the invention provides a projection apparatus including a light source module, a light valve unit, and a projection lens. The light source module includes a light source and a light diffusion and filtering plate. The light source is configured to provide an illumination light beam. The light diffusion and filtering plate is disposed on a transmission path of the illumination light beam. The light diffusion and filtering plate includes a light-transparent substrate, a light diffusion structure, and a light filtering structure. The light-transparent substrate has a first surface facing to the light source and a second surface opposite to the first surface. The light diffusion structure is disposed on the first surface, and the light filtering structure is disposed on the second surface. The light valve unit is disposed on the transmission path of the illumination light beam from the light diffusion and filtering plate to convert the illumination light beam into an image light beam. The projection lens is disposed on a transmission path of the image light beam.

In order to achieve one or a portion of or all of the objects or other objects, an embodiment of the invention provides a light source module including a light source and a light diffusion and filtering plate. The light source is configured to provide an illumination light beam. The light diffusion and filtering plate is disposed on a transmission path of the illumination light beam. The light diffusion and filtering plate includes a light-transparent substrate, a light diffusion structure, and a light filtering structure. The light-transparent substrate has a first surface facing to the light source and a second surface opposite to the first surface. The light diffusion structure is disposed on the first surface, and the light filtering structure is disposed on the second surface.

In embodiments of the projection apparatus and the light source module of the invention, the light filtering structure includes an infrared filtering layer and an ultraviolet filtering layer, and the ultraviolet filtering layer is disposed between the infrared filtering layer and the second surface.

In embodiments of the projection apparatus and the light source module of the invention, the light diffusion structure is formed by a surface treatment of the first surface.

In embodiments of the projection apparatus and the light source module of the invention, the surface treatment includes at least one of a grinding process, a sandblasting process, a chemical etching process, and any combinations thereof.

In embodiments of the projection apparatus and the light source module of the invention, the light diffusion structure has a half width at half maximum (HWHM) diffusion angle of 1.8°±0.3°.

In embodiments of the projection apparatus and the light source module of the invention, the light-transparent substrate is a glass substrate.

In embodiments of the projection apparatus and the light source module of the invention, the light diffusion and filtering plate further includes an anti-reflection layer, wherein the light diffusion structure is disposed between the anti-reflection layer and the light-transparent substrate.

In embodiments of the projection apparatus and the light source module of the invention, the light source is a mercury lamp.

In embodiments of the projection apparatus and the light source module of the invention, the light source module further includes a light integration rod disposed on the transmission path of the illumination light beam, and the light diffusion and filtering plate is disposed between the light source and the light integration rod.

In embodiments of the projection apparatus and the light source module of the invention, the light integration rod includes a hollow rod and a holder surrounding the hollow rod.

In the projection apparatus and the light source module of the embodiments of the invention, since the light diffusion and filtering plate includes the light diffusion structure disposed on the first surface of the light-transparent substrate to diffuse the illumination light beam from the light source, the flicker may be reduced.

Other objectives, features and advantages of the present invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a projection apparatus according to an embodiment of the invention;

FIG. 2 is a schematic cross-sectional view of a light diffusion and filtering plate of a light source module according to an embodiment of the invention;

FIG. 3 is a schematic view showing a light intensity distribution of a laser beam after passing through a light diffusion structure according to an embodiment of the invention;

FIG. 4 is a schematic cross-sectional view of a light integration rod of a light source module according to an embodiment of the invention; and

FIG. 5 is a schematic cross-sectional view of a light diffusion and filtering plate of a light source module according to another embodiment of the invention.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

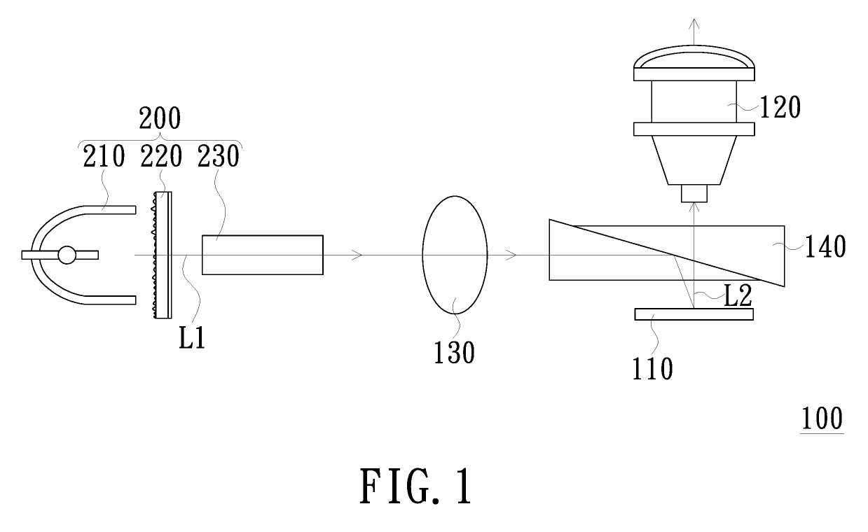

FIG. 1 is a schematic view of a projection apparatus according to an embodiment of the invention. Referring to FIG. 1, a projection apparatus 100 of the embodiment includes a light source module 200, a light valve unit 110, and a projection lens 120. The light source module 200 includes a light source 210 and a light diffusion and filtering plate 220. The light source 210 is configured to provide an illumination light beam L1. The light diffusion and filtering plate 220 is disposed on a transmission path of the illumination light beam L1. The light valve unit 110 is disposed on the transmission path of the illumination light beam L1 from the light diffusion and filtering plate 220 to convert the illumination light beam L1 into an image light beam L2. The projection lens 120 is disposed on a transmission path of the image light beam L2. In the embodiment of the invention, the projection lens 120 is further configured to convert the image light beam L2 into a projection light beam (not shown) for projecting the projection light beam onto a screen (not shown) to display an image onto the screen.

In the embodiment of the invention, the light valve unit 110 includes, for example, a reflective light valve, such as a digital micro-mirror device (DMD) or a liquid crystal on silicon panel (LCOS panel). In another embodiment, the light valve unit may include a transmissive light valve, such as a transmissive liquid crystal display panel (transmissive LCD panel). In other embodiments, the light valve unit may include a plurality of light valves, for example, three light valves. However, the invention is not limited thereto.

The projection apparatus 100 may further include at least one optical element disposed between the light source module 200 and the light valve unit 110 and/or between the light valve unit 110 and the projection lens 120. In the embodiment, the at least one optical element includes, for example, a lens 130 and a total internal reflection (TIR) prism 140, though the invention is not limited thereto. In the embodiment, the lens 130 and the total internal reflection (TIR) prism 140 are used for collecting, directing the illumination light beam L1 toward the light valve unit 110, for example.

In the embodiment, the lens 130 is disposed between the light source module 200 and the total internal reflection prism 140, and the total internal reflection prism 140 is disposed among the lens 130, the light valve unit 110, and the projection lens 120.

In the embodiment, the light source 210 may be, but not limited to, a mercury lamp. The mercury lamp may be a high pressure mercury lamp. In another embodiment, the light source 210 may be a light emitting diode assembly, a laser device assembly, or other suitable light emitting device(s). However, the invention is not limited thereto.

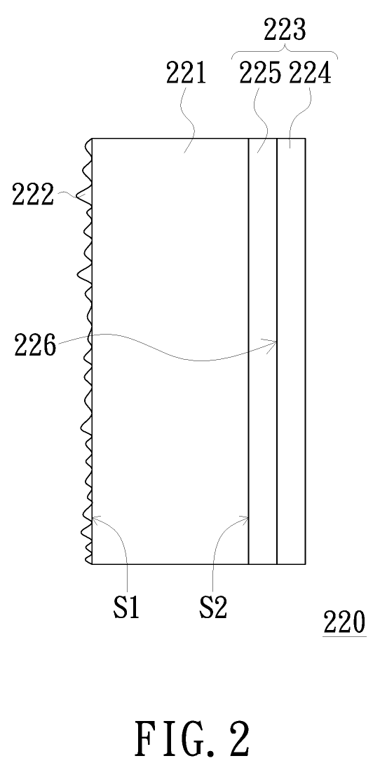

FIG. 2 is a schematic cross-sectional view of a light diffusion and filtering plate of a light source module according to an embodiment of the invention. Referring to FIGS. 1 and 2, the light diffusion and filtering plate 220 includes a light-transparent substrate 221, a light diffusion structure 222, and a light filtering structure 223. The light-transparent substrate 221 has a first surface S1 facing to the light source 210 and a second surface S2 opposite to the first surface S1. The light diffusion structure 222 is disposed on the first surface S1, and the light filtering structure 223 is disposed on the second surface S2.

In the embodiment of the invention, the light-transparent substrate 221 may be a glass substrate, or made of other high temperature resistant material, though the invention is not limited thereto. In the embodiment, the light filtering structure 223 is an invisible light cut-off filter or the light filtering structure 223 has invisible light cut-off filtering function. More specifically, in the embodiment, the light filtering structure 223 includes, for example, an infrared filtering layer 224 and an ultraviolet filtering layer 225, and the ultraviolet filtering layer 225 is disposed between the infrared filtering layer 224 and the second surface S2 of the light-transparent substrate 221. In the embodiment, the infrared filtering layer 224 is configured to cut off infrared rays of the illumination light beam L1, and the ultraviolet filtering layer 225 is configured to cut off ultraviolet rays of the illumination light beam L1.

In the embodiment of the invention, the infrared filtering layer 224 is disposed on a surface 226 of the ultraviolet filtering layer 225 and the surface 226 is away from the light-transparent substrate 221, such that the radiant heat of the infrared rays does not be accumulated between the infrared filtering layer 224 and the light-transparent substrate 221, thereby the light-transparent substrate 221 is prevented from breaking.

In the embodiment of the invention, the light diffusion structure 222 is, for example, formed by a surface treatment of the first surface S1. The surface treatment may include at least one of a grinding process, a sandblasting process, a chemical etching process, and any combinations thereof. In another embodiment, the light diffusion structure 222 may be a light diffusion film adhered on the first surface S1. However, the light diffusion structure 222 may be formed on the light-transparent substrate 221 in any suitable structure/type/appearance, for example the light diffusion structure 222 integrated forms on the first surface S1 of the light-transparent substrate 221, and the invention is not limited thereto.

In the embodiment, the light diffusion structure 222 may diffuse light rays of the illumination light beam L1 to uniform the illumination light beam L1. Even if the illumination light beam L1 from the light source 210 has flicker, the light diffusion structure 222 may reduce the flicker, and thus the image displayed onto the screen does not exist a flicker defect, and uniformity brightness of the image will be improved. Further, in the embodiment, since the light diffusion structure 222 and the light filtering structure 223 may be combined as one element, numbers of elements of the light source module 200 may be reduced, and costs of the light source module 200 and the projection apparatus 100 are also reduced.

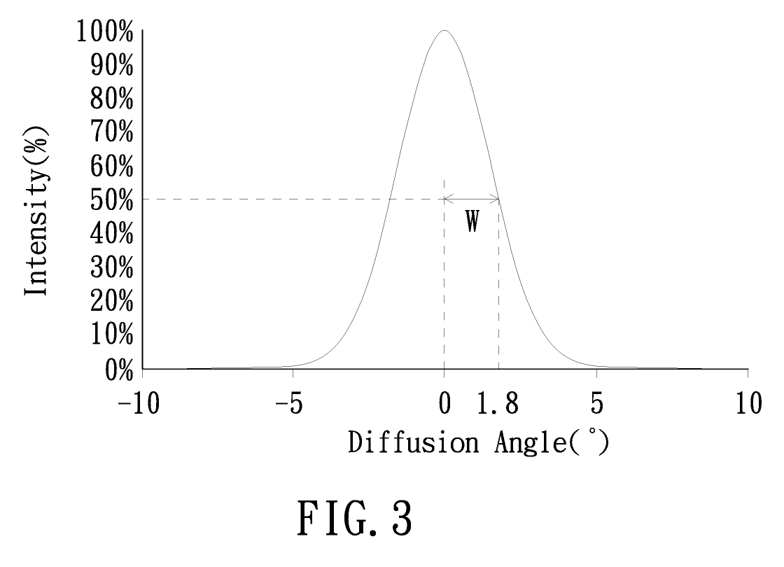

FIG. 3 is a schematic view showing a light intensity distribution of a laser beam after passing through a light diffusion structure according to an embodiment of the invention. Referring to FIGS. 2 and 3, the light diffusion structure 222 of FIG. 2 may have a half width at half maximum (HWHM) diffusion angle of 1.8°±0.3°. More specifically, the laser beam passing through the light diffusion structure 222 of FIG. 2 may have the light intensity distribution as shown in FIG. 3, and the light intensity distribution is within a HWHM diffusion angle of 1.8°±0.3° and the half width is W when the light intensity is 50%.

Flicker values of the image displayed onto the screen are listed in Table 1 to further illustrate the light diffusion structure 222 may indeed reduce the flicker. In Table 1, three light valve units with XGA, WXGA, and WUXGA resolutions respectively are mentioned.

TABLE 1
Flicker (%)

| | |
|---|---|
| Without the light | With the light diffusion |
| diffusion structure 222 | structure 222 |

XGA

| | | |
|---|---|---|
| Maximum | 3.6 | 1.8 |
| Minimum | 2.3 | 1.5 |
| Average | 2.8 | 1.6 |

WXGA

| | | |
|---|---|---|
| Maximum | 3.8 | 2 |
| Minimum | 2.2 | 1.4 |
| Average | 2.5 | 1.6 |

WUXGA

| | | |
|---|---|---|
| Maximum | 3.9 | 3.2 |
| Minimum | 2.3 | 1.4 |
| Average | 3 | 2 |

Referring to FIG. 1, in the embodiment, the light source module 200 may further include a light integration rod 230 disposed on the transmission path of the illumination light beam L1, and the light diffusion and filtering plate 220 is disposed between the light source 210 and the light integration rod 230. In the embodiment, the light integration rod 230 is configured to uniform the illumination light beam L1. In the embodiment, since the light diffusion structure 222 is capable of uniforming the illumination light beam L1, a size of the light integration rod 230 may be reduced, thereby a size of the light source module 200 and a size of the projection apparatus 100 may be reduced.

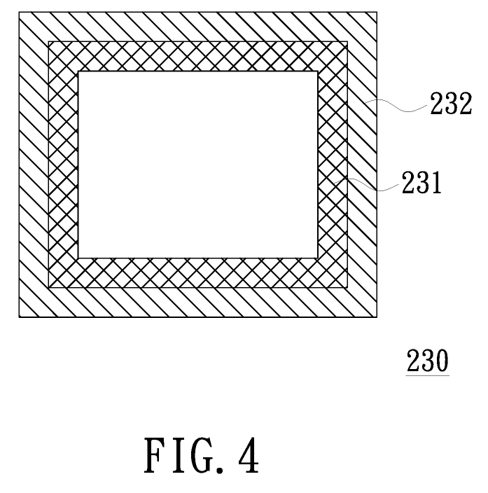

FIG. 4 is a schematic cross-sectional view of a light integration rod of a light source module according to an embodiment of the invention. Referring to FIG. 4, in an embodiment, the light integration rod 230 includes, for example, a hollow rod 231 and a holder 232 surrounding the hollow rod 231. The hollow rod 231 may be made of glass or other high temperature resistant material with total reflection coating for reflecting the light beam. The holder 232 may be made of metal or other suitable material for holding the hollow rod 231, so that the hollow rod 231 may be fixed on the holder 232. However, the invention does not limit materials of the hollow rod 231 and the holder 232. In another embodiment, the light integration rod 230 may be a solid rod.

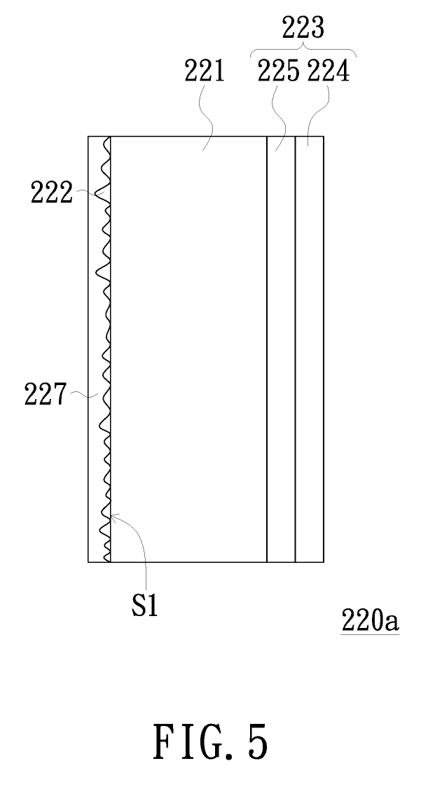

FIG. 5 is a schematic cross-sectional view of a light diffusion and filtering plate of a light source module according to another embodiment of the invention. Referring to FIG. 5, the light diffusion and filtering plate 220a is similar to light diffusion and filtering plate 220 of FIG. 2, the major difference is the light diffusion and filtering plate 220a further includes an anti-reflection layer 227, wherein the light diffusion structure 222 is disposed between the anti-reflection layer 227 and the light-transparent substrate 221. In the embodiment, the anti-reflection layer 227 may be coated on the light diffusion structure 222 to further cover the light diffusion structure 222. In the embodiment, the anti-reflection layer 227 may prevent the above-mentioned illumination light beam L1 (shown in FIG. 1) from being reflected back to the above-mentioned light source 210 (shown in FIG. 1) to increase utilization efficiency of the light from the light source 210.

In summary, in the projection apparatus and the light source module of the embodiments of the invention, since the light diffusion and filtering plate includes the light diffusion structure disposed on the first surface of the light-transparent substrate to diffuse the illumination light beam from the light source, the flicker is reduced. Further, in some embodiments of the invention, the light diffusion structure and the light filtering structure are combined as one element, numbers of elements of the light source module may be reduced, and thus costs of the light source module and the projection apparatus of the embodiments of the invention are also reduced. Moreover, in an embodiment, since the light diffusion structure and the light integration rod are capable of uniforming the illumination light beam, the size of the light integration rod may be reduced, thereby the size of the light source module and the size of the projection apparatus may be reduced.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first surface and the second surface are only used for distinguishing various elements and do not limit the number of the elements.

1. A projection apparatus, comprising:
a light source module, comprising:
a light source, configured to provide an illumination light beam; and
a light diffusion and filtering plate, disposed on a transmission path of the illumination light beam, the light diffusion and filtering plate comprising a light-transparent substrate, a light diffusion structure, and a light filtering structure, wherein the light-transparent substrate has a first surface facing to the light source and a second surface opposite to the first surface, the light diffusion structure is disposed on the first surface, and the light filtering structure is disposed on the second surface, wherein the light filtering structure comprises an infrared filtering layer and an ultraviolet filtering layer, and the ultraviolet filtering layer is disposed between the infrared filtering layer and the second surface;
a light valve unit, disposed on the transmission path of the illumination light beam from the light diffusion and filtering plate to convert the illumination light beam into an image light beam; and
a projection lens, disposed on a transmission path of the image light beam.

2. (canceled)

3. The projection apparatus according to claim 1, wherein the light diffusion structure is formed by a surface treatment of the first surface.

4. The projection apparatus according to claim 3, wherein the surface treatment comprises at least one of a grinding process, a sandblasting process, a chemical etching process, and any combinations thereof.

5. The projection apparatus according to claim 1, wherein the light diffusion structure has a HWHM diffusion angle of 1.8°±0.3°.

6. The projection apparatus according to claim 1, wherein the light-transparent substrate is a glass substrate.

7. The projection apparatus according to claim 1, wherein the light diffusion and filtering plate further comprises an anti-reflection layer, and the light diffusion structure is disposed between the anti-reflection layer and the light-transparent substrate.

8. The projection apparatus according to claim 1, wherein the light source is a mercury lamp.

9. The projection apparatus according to claim 1, wherein the light source module further comprises a light integration rod disposed on the transmission path of the illumination light beam, and the light diffusion and filtering plate is disposed between the light source and the light integration rod.

10. The projection apparatus according to claim 9, wherein the light integration rod comprises a hollow rod and a holder surrounding the hollow rod.

11. A light source module, comprising:
a light source, configured to provide an illumination light beam; and
a light diffusion and filtering plate, disposed on a transmission path of the illumination light beam, the light diffusion and filtering plate comprising a light-transparent substrate, a light diffusion structure, and a light filtering structure, wherein the light-transparent substrate has a first surface facing to the light source and a second surface opposite to the first surface, the light diffusion structure is disposed on the first surface, and the light filtering structure is disposed on the second surface, wherein the light filtering structure comprises an infrared filtering layer and an ultraviolet filtering layer, and the ultraviolet filtering layer is disposed between the infrared filtering layer and the second surface.

12. (canceled)

13. The light source module according to claim 11, wherein the light diffusion structure is formed by a surface treatment of the first surface.

14. The light source module according to claim 13, wherein the surface treatment comprises at least one of a grinding process, a sandblasting process, a chemical etching process, and any combinations thereof.

15. The light source module according to claim 11, wherein the light diffusion structure has a HWHM diffusion angle of 1.8°±0.3°.

16. The light source module according to claim 11, wherein the light-transparent substrate is a glass substrate.

17. The light source module according to claim 11, wherein the light diffusion and filtering plate further comprises an anti-reflection layer, and the light diffusion structure is disposed between the anti-reflection layer and the light-transparent substrate.

18. The light source module according to claim 11, wherein the light source is a mercury lamp.

19. The light source module according to claim 11, further comprising a light integration rod disposed on the transmission path of the illumination light beam, wherein the light diffusion and filtering plate is disposed between the light source and the light integration rod.

20. The light source module according to claim 19, wherein the light integration rod comprises a hollow rod and a holder surrounding the hollow rod.
